(19) United States
(12) Patent Application Publication
(10) Pub. No.: US 2013/0076996 A1
(43) Pub. Date: Mar. 28, 2013

(54) INTEGRATED TOUCH PANEL WITH DISPLAY DEVICE AND METHOD OF MANUFACTURING THE SAME

(71) Applicant: Katsunori Misaki, Yonago-shi (JP)

(72) Inventor: Katsunori Misaki, Yonago-shi (JP)

(73) Assignee: SHARP KABUSHIKI KAISHA, Osaka (JP)

(21) Appl. No.: 13/702,191

(22) PCT Filed: May 27, 2011
(86) PCT No.: PCT/JP2011/062273

§ 371 Date: Dec. 5, 2012

(30) Foreign Application Priority Data
Jun. 11, 2010 (JP) 2010-134346

(51) Int. Cl. G02F 1/1333; H01H 11/00

(52) U.S. Cl. CPC G02F 1/13338; H01H 11/00
USPC 349/12; 29/622

(57) ABSTRACT

A protective film has a first protective film (8) made of a silicon oxide film or a silicon nitride oxide film, a second protective film (9) made of a silicon nitride film, and a third protective film (10) made of a transparent resin film. The third protective film (10) is formed in a layer above the first protective film (8) and the second protective film (9). With this configuration, a liquid crystal display device-integrated touch panel (1) with long-term reliability can be realized.

### TECHNICAL FIELD

The present invention relates to a display device-integrated touch panel and a method of manufacturing the same.

### BACKGROUND ART

In recent years, a touch panel has been widely used as an input unit for operating a multifunctional electronic device such as a PDA (Personal Digital Assistant), an MP3 player, and a car navigation system. In order to display images such as icons, letters, and the like corresponding to general operations that can be inputted, such an electronic device equipped with a touch panel is provided with a display unit that can change images, letters, and the like, as necessary, on the back of the transparent touch panel.

FIG. 8 is a cross-sectional view showing a conventional capacitive display device-integrated touch panel, which is used as widely as a resistive touch panel.

As shown in FIG. 8, a touch panel 200 is provided with a substrate 250 bonded to an upper substrate 102 of a liquid crystal display device 100 by an adhesive layer 110, a conductive film 251 disposed on the substrate 250, and a protective film 252 formed to cover the conductive film 251.

The liquid crystal display device 100 is provided with a lower substrate 101, the upper substrate 102 facing the lower substrate 101, pixel electrodes 104 and a common electrode 105 formed on respective surfaces of the substrates 101 and 102 facing each other, spacers 106 sandwiched between the pixel electrodes 104 and the common electrode 105 to control a gap, liquid crystal 107 filled between the pixel electrodes 104 and the common electrode 105, and a sealing material 103 that seals the liquid crystal 107 and that bonds the lower substrate 101 and the upper substrate 102.

The capacitive touch panel 200 integrated with the display device detects coordinates by detecting electrostatic capacitance formed between a finger (or a pen) and the conductive film 251.

However, in this configuration, parasitic capacitance is formed between the conductive film 251 and the common electrode 105. This parasitic capacitance causes a decrease in accuracy in detecting the coordinates.

More specifically, in the configuration shown in FIG. 8, the liquid crystal display device 100 and the touch panel 200 are bonded by the adhesive layer 110. When a finger or the like makes an input at a certain set of coordinates, the adhesive layer 110 is deformed greatly because of stress resulting from the input, which causes a distance between the conductive film 251 and the common electrode 105 to change. This results in a change in a value of the parasitic capacitance. The change in parasitic capacitance greatly affects accuracy in detecting the coordinates, causing a discrepancy between a detected position and a position where a finger or the like actually touched.

In Patent Document 1, a display device-integrated touch panel that does not have the adhesive layer 110, which is a main cause of the discrepancy described above, is disclosed.

FIG. 9 is a cross-sectional view showing a conventional capacitive display device-integrated touch panel that does not have the adhesive layer 110 and that therefore has higher accuracy in detecting a position of coordinates.

As shown in FIG. 9, on the upper substrate 102 provided in the liquid crystal display device 100, the conductive film 251 is disposed. The upper substrate 102 is sandwiched between the conductive film 251 and the common electrode 105. Other configurations shown in FIG. 9 are the same as those shown in FIG. 8.

In the above configuration shown in FIG. 9, the liquid crystal display device 100 and the touch panel 200 share the upper substrate 102. This way, even when a stress is applied by a finger or the like upon making an input on the touch panel 200 by the finger or the like, a distance between the common electrode 105 and the conductive film 251 is not changed. Therefore, parasitic capacitance formed between the common electrode 105 and the conductive film 251 is not changed. Thus, according to this configuration, a capacitive display device-integrated touch panel that has high accuracy in detecting a position of coordinates can be achieved.

In Patent Document 2, a configuration shown in FIG. 10 is disclosed. In this configuration, a transparent electrode film made of ITO (Indium Tin Oxide) or the like is deposited on a glass substrate 301 by sputtering or the like. Next, this transparent electrode film is patterned, thereby forming striped electrodes 302. Next, a gas barrier layer 303 made of a silicon oxide film or the like is deposited on the electrodes 302. Thereafter, an acrylic or epoxy transparent resin layer to be a transparent substrate (plastic substrate) 304 is deposited on the gas barrier layer 303.

Patent Document 2 describes that, by removing the glass substrate 301 through etching using an etchant (acid) in which HF and HNO₃ are mixed in a ratio of 1:20, for example, a substrate for a liquid crystal display device provided with the striped electrodes 302 on one surface of the transparent substrate (plastic substrate) 304 can be made.

### RELATED ART DOCUMENTS

### Patent Documents

Patent Document 1: WO 2008/050507 (published on May 2, 2008)
Patent Document 2: Japanese Patent Application Laid-Open Publication No. 2002-90712 (published on Mar. 27, 2002)

### SUMMARY OF THE INVENTION

### Problems to be Solved by the Invention

However, in Patent Document 1, a material of the protective film 252 that is formed to cover the conductive film 251 shown in FIG. 9 is not specifically mentioned, and problems described below that occur depending on the material of the protective film 252 are not discussed at all.

FIG. 11 is a plan view of the touch panel 200 shown in FIG. 9. In FIG. 11, a region R1 where the conductive film 251 is formed (a section along the line A-A′), a region R2 where wiring lines 253 are formed (a section along the line B-B′), and a region R3 where a terminal section (a contact hole 254) is formed (a section along the line C-C′) are shown.

FIGS. 12(a) to 12(c) are cross-sectional views of the respective regions shown in FIG. 11. FIG. 12(a) is a cross-sectional view showing the region R1 where the conductive film 251 is formed (along the line A-A′ in FIG. 11). FIG. 12(b) is a cross-sectional view showing the region R2 where the wiring line 253 is formed (along the line B-B′ in FIG. 11). FIG. 12(c) is a cross-sectional view showing the region R3 where the terminal section (the contact hole 254) is formed (along the line C-C′ in FIG. 11).

In the region where the conductive film 251 is formed, as shown in FIG. 12(a), the conductive film 251 made of a transparent conductive element such as ITO or IZO (Indium Zinc Oxide) is formed on a surface of the upper substrate 102 of the liquid crystal display device 100. This surface is on the reverse side from the surface on which the common electrode 105 (not shown) is formed. As shown in FIG. 11, the conductive film 251 is formed in a stripe shape, and parts of the conductive film 251 formed in a stripe shape are electrically connect to each other. Further, the protective film 252 is formed so as to cover the conductive film 251.

As shown in FIG. 12(b), in the region where the wiring line 253 is formed, the wiring line 253 made by laminating an Al layer and an Mo/Nb layer, for example, is formed on a surface of the upper substrate 102 of the liquid crystal display device 100. This surface is on the reverse side from the surface on which the common electrode 105 (not shown) is formed. Further, the protective film 252 is formed so as to cover the wiring line 253.

As shown in FIG. 12(c), in the region where the terminal section (contact hole 254) is formed, the wiring line 253 made by laminating the Al layer and the Mo/Nb layer, for example, is formed on a surface of the upper substrate 102 of the liquid crystal display device 100. This surface is on the reverse side from the surface on which the common electrode 105 (not shown) is formed. Further, the conductive film 251 is formed so as to cover the wiring line 253, and the contact hole 254 is formed in the protective film 252 such that part of the conductive film 251 is exposed.

In this configuration, when the protective film 252 is formed of a transparent insulating resin, for example, the protective film 252 absorbs moisture in the air, the moisture reaches the wiring line 253, and the wiring line 253 is corroded after prolonged use of the display device. Therefore, it is difficult to achieve a display device-integrated touch panel with long-term reliability.

FIG. 13 is a diagram showing a pinhole (crack) formed in the protective film 252 at an area where the protective film 252 makes contact with a support pin 255 in the region where the wiring line 253 is formed. Here, the protective film 252 is made of a silicon oxide film or a silicon nitride film having a high degree of hardness.

In order for the liquid crystal display device 100 and the touch panel 200 to share the upper substrate 102 of the liquid crystal display device 100 as shown in FIG. 9, the common electrode 105, a color filter layer, and the like need to be formed on a surface of the upper substrate 102 on the reverse side from the surface on which the conductive film 251 and the wiring lines 253 are formed. In a process of forming the common electrode 105, the color filter layer, and the like, as shown in FIG. 13, it is inevitable that the protective film 252 makes contact with the support pins 255 that are substrate carriers. When the protective film 252 is formed of a silicon oxide film or a silicon nitride film having a high degree of hardness, this contact results in a pinhole (crack) made in the protective film 252, which causes breaking or corrosion of the wiring lines 253.

In Patent Document 2, the configuration shown in FIG. 10 is disclosed. In this configuration, the gas barrier layer 303 made of a silicon oxide film or the like and the transparent substrate (plastic substrate) 304 made of a transparent resin layer are laminated and cover the striped electrodes 302.

In the above-mentioned configuration, the transparent resin layer is used as one substrate of the liquid crystal display device as in a typical liquid crystal display device that has a substrate made of a material that does not have elasticity so as to make it easier to adjust the cell thickness. However, because the transparent resin layer has little elasticity, it is likely to be damaged in the subsequent processes, and therefore, it is difficult to achieve long-term reliability of the display device-integrated touch panel having this configuration.

Further, in this configuration, the gas barrier layer 303 that is made of the silicon oxide film or the like and that is lying under the transparent resin layer undergoes a stress and is damaged. This may cause breaking or corrosion of the wiring lines.

The present invention was made in view of the above problems, and aims at providing a display device-integrated touch panel that can ensure long-term reliability and a method of manufacturing the same.

### Means for Solving the Problems

In order to solve the above problems, a display device-integrated touch panel of the present invention is a display device-integrated touch panel, provided with: a capacitive touch panel that is formed on a surface on one side of an insulating substrate and that includes: a conductive film; a terminal for detecting an electric charge; wiring electrically connecting the conductive film to the terminal; and a protective film formed to cover the conductive film and the wiring, the touch panel detecting a position touched from outside by using electrostatic capacitance formed between the conductive film and a pressing object as a result of a pressure from the outside; and a display device formed on the other side of the insulating substrate, the display device using the insulating substrate as a substrate on a display surface side, wherein the protective film is formed of a multilayer film made of a silicon nitride film, a silicon oxide film or a silicon nitride oxide film, and a transparent resin film, and wherein the transparent resin film is formed in a layer above the silicon nitride film and the silicon oxide film or the silicon nitride oxide film in a thickness direction of the insulating substrate.

In the conventional protective film that was formed only of the transparent resin film, the transparent resin film absorbed moisture in the air, the moisture reached the wiring lines, and the wiring lines became corroded after prolonged use of the display device. On the other hand, according to the above-mentioned configuration, the protective film is formed of the multilayer film of the silicon nitride film, the silicon oxide film or the silicon nitride oxide film, and the transparent resin film. This way, the problem described above can be prevented, and therefore, it becomes possible to achieve a display device-integrated touch panel with long-term reliability.

In the protective film having the above configuration, the transparent resin film is formed in a layer above the silicon nitride film and the silicon oxide film or the silicon nitride oxide film in a thickness direction of the insulating substrate (in a film thickness direction of the insulating substrate in which the silicon nitride film, and the silicon oxide film or the silicon nitride oxide film are formed).

The protective film is not formed as one substrate of the display device. This allows the transparent resin layer of the protective film to have elasticity. Therefore, it becomes possible to make the transparent resin layer of the protective film less susceptible to damage.

When prescribed films such as a color filter film and an alignment film, for example, are formed on a surface on the other side of the insulating substrate, the insulating substrate needs to be turned over so as to be transferred with the front side facing down. At this time, support pins that are substrate carriers make contact with the transparent resin layer of the protective film. The protective film is not formed as one substrate of the display device, and can be formed such that the transparent resin layer of the protective film has elasticity, which makes a pinhole (crack) less likely to be formed. Therefore, it becomes possible to prevent the wiring lines from being broken or corroded as a result of a pinhole (crack). Thus, it becomes possible to achieve a display device-integrated touch panel with long-term reliability.

In order to solve the above problems, a method of manufacturing a display device-integrated touch panel of the present invention is a method of manufacturing a display device-integrated touch panel that is provided with: a capacitive touch panel that is formed on a surface on one side of an insulating substrate and that has: a conductive film; a terminal for detecting an electric charge; wiring electrically connecting the conductive film to the terminal; and a protective film formed to cover the conductive film and the wiring, the touch panel detecting a position touched from outside by using electrostatic capacitance formed between the conductive film and a pressing object as a result of a pressure applied from the outside; and a display device formed on the other side of the insulating substrate, the display device using the insulating substrate as a substrate on a display surface side, the method including: in a process of forming the protective film, a step of forming a silicon nitride film; a step of forming a silicon oxide film or a silicon nitride oxide film; and a step of forming a transparent resin film, wherein the step of forming the transparent resin film is performed after the step of forming the silicon nitride film and the step of forming the silicon oxide film or the silicon nitride oxide film, wherein the method further includes: turning over the insulating substrate such that a front side faces down after the step of forming the transparent resin film; and forming a prescribed film on a surface on the other side of the insulating substrate.

According to the above manufacturing method, the prescribed films such as a color filter layer and an alignment film, for example, are formed on the surface on the other side of the insulating substrate. The step of forming the transparent resin film is performed after the step of forming the silicon nitride film and the step of forming the silicon oxide film or the silicon nitride oxide film. After the step of forming the transparent resin film was performed, the insulating substrate is turned over such that the front side faces down, and the prescribed films are formed on the surface on the other side of the insulating substrate.

When the prescribed films are formed on the surface on the other side of the insulating substrate, the insulating substrate needs to be turned over so as to be transferred with the front side facing down. At this time, the support pins that are the substrate carriers make contact with the transparent resin layer of the protective film.

In the above-mentioned configuration, the protective film is not formed as one substrate of the liquid crystal display device, and can be formed such that the transparent resin layer of the protective film has elasticity, which makes a pinhole (crack) less likely to be formed. Therefore, it becomes possible to prevent the wiring lines from being broken or corroded as a result of a pinhole (crack). Thus, it becomes possible to achieve a method of manufacturing a display device-integrated touch panel with long-term reliability.

### Effects of the Invention

In the display device-integrated touch panel of the present invention, as described above, the protective film is formed of the multilayer film made of the silicon nitride film, the silicon oxide film or the silicon nitride oxide film, and the transparent resin film. The transparent resin film is formed in a layer above the silicon nitride film and the silicon oxide film or the silicon nitride oxide film in a thickness direction of the insulating substrate.

In the method of manufacturing the display device-integrated touch panel of the present invention, as described above, the process of forming the protective film has the step of forming the silicon nitride film, the step of forming the silicon oxide film or the silicon nitride oxide film, and the step of forming the transparent resin film. The step of forming the transparent resin film is performed after the step of forming the silicon nitride film and the step of forming the silicon oxide film or the silicon nitride oxide film. The insulating substrate is turned over such that the front side faces down after the step of forming the transparent resin film was performed, and on the surface on the other side of the insulating substrate, the prescribed films are formed.

Therefore, it becomes possible to achieve a display device-integrated touch panel with long-term reliability and a method of manufacturing the same.

### BRIEF DESCRIPTION OF THE DRAWINGS

FIG. 1 is a schematic cross-sectional view showing a region where a conductive film (electrode) is formed in a touch panel unit of a liquid crystal display device-integrated touch panel in one embodiment of the present invention.

FIG. 2 is a schematic cross-sectional view showing the touch panel unit of the liquid crystal display device-integrated touch panel in one embodiment of the present embodiment. FIG. 2(a) shows a wiring forming region. FIG. 2(b) shows a terminal section forming region having a contact hole.

FIG. 3 is a schematic diagram for explaining a process of manufacturing the touch panel unit of the liquid crystal display device-integrated touch panel in one embodiment of the present invention.

FIG. 4 is a schematic diagram for explaining a process of manufacturing a touch panel unit of a conventional liquid crystal display device-integrated touch panel.

FIG. 5 is a diagram illustrating an overview of the process of manufacturing the liquid crystal display device-integrated touch panel in one embodiment of the present invention.

FIG. 6 is a schematic cross-sectional view showing the conventional liquid crystal display device-integrated touch panel.

FIG. 7 is a schematic cross-sectional view showing the liquid crystal display device-integrated touch panel in one embodiment of the present invention.

FIG. 8 is a schematic cross-sectional view showing a conventional capacitive display device-integrated touch panel.

FIG. 9 is a schematic cross-sectional view showing the conventional display device-integrated capacitive touch panel that has improved accuracy in detecting a position of coordinates.

FIG. 10 is a diagram showing a conventional configuration in which a transparent electrode film is formed between a glass substrate and a plastic substrate.

FIG. 11 is a plan view of a touch panel unit of the display device-integrated touch panel shown in FIG. 9.

FIG. 12 is a cross-sectional view showing respective regions in the touch panel unit of the display device-integrated touch panel shown in FIG. 11. FIG. 12(a) shows a conductive film forming region (a section along the line A-A′ in FIG. 11). FIG. 12(b) shows a wiring forming region (a section along the line B-B′ in FIG. 11). FIG. 12(c) shows a terminal section forming region (a section along the line C-C′ in FIG. 11).

FIG. 13 is a diagram showing a pinhole (crack) formed in the wiring forming region in the touch panel unit of the display device-integrated touch panel shown in FIG. 11, when a protective film is formed of a silicon oxide film or a silicon nitride film having a high degree of hardness.

### DETAILED DESCRIPTION OF EMBODIMENTS

Embodiments of the present invention will be described below in detail with reference to figures. However, dimensions, materials, forms, relative arrangement, and the like of components described in the embodiments are mere examples, and the scope of the present invention should not be narrowly interpreted by these examples.

(Configuration of Liquid Crystal Display Device-Integrated Touch Panel)

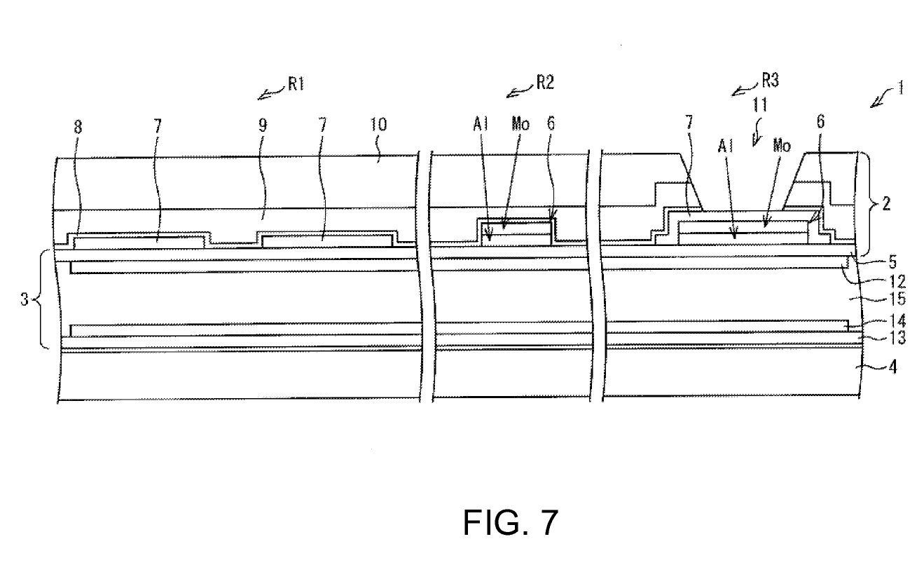

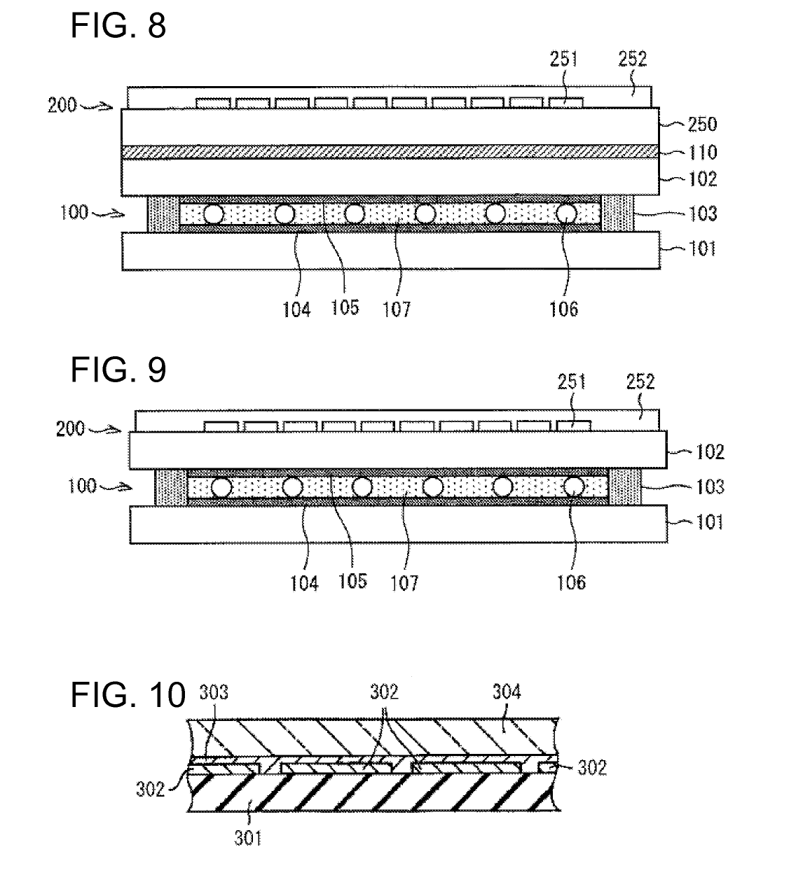

FIG. 7 is a schematic cross-sectional view showing a liquid crystal display device-integrated touch panel 1.

As shown in FIG. 7, the liquid crystal display device-integrated touch panel 1 is provided with a capacitive touch panel unit 2 (a touch panel that detects a position where a finger makes contact, using electrostatic capacitance formed between a conductive film 7, which will be described later, and a finger (pressing object) when the touch panel is pressed from the outside), a liquid crystal display panel unit 3, and a backlight unit 4 that emits planar and uniform light to the liquid crystal display panel unit 3.

The touch panel unit 2 uses an opposite substrate 5 (insulating substrate), which is an upper substrate of the liquid crystal display panel unit 3, as a base of the touch panel unit 2. On the entire surface of the opposite substrate 5 on the viewer's side (i.e., on a surface of the opposite substrate 5 on the reverse side from the surface facing the backlight unit 4), an Al layer and an Mo layer are deposited in this order by sputtering or the like. These layers are patterned in a prescribed shape, thereby forming wiring lines 6.

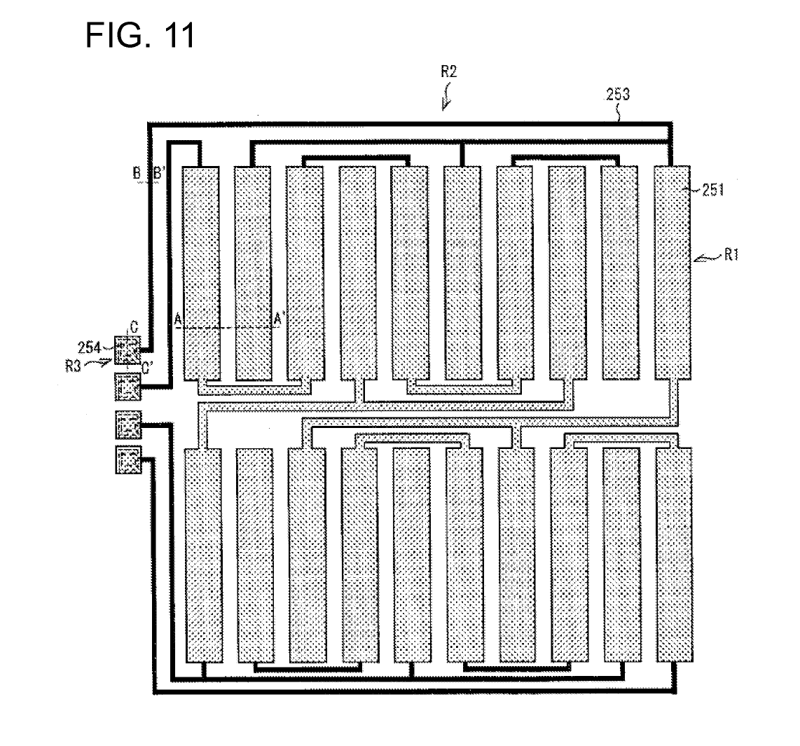

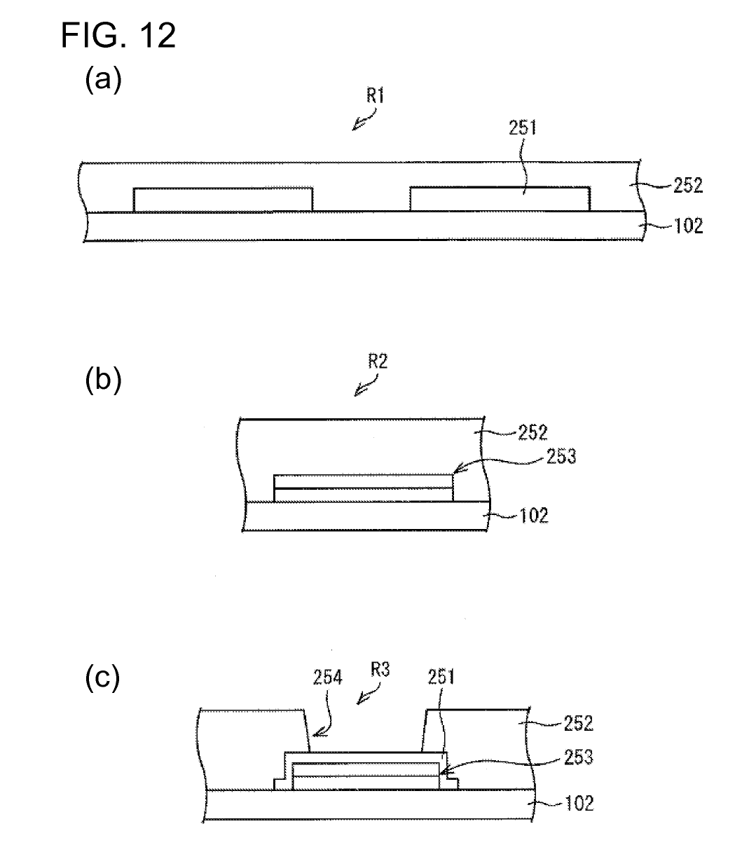

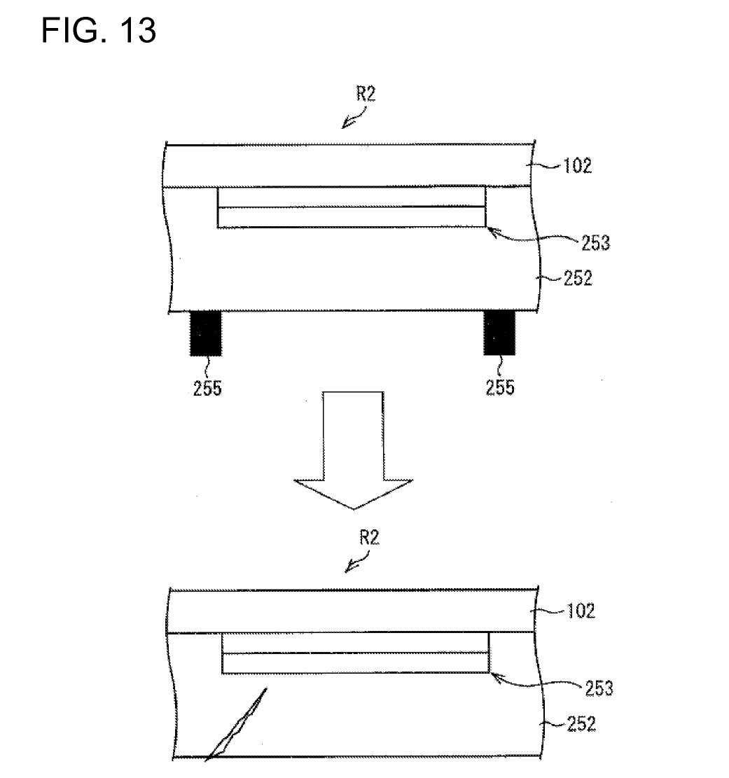

The wiring lines 6 correspond to the wiring lines 253 shown in FIG. 11, which are formed so as to electrically connect portions of the conductive film 251 to each other and electrically connect the conductive film 251 to the terminal section (indicated with the line C-C′ in FIG. 11). In the liquid crystal display device-integrated touch panel 1, the wiring lines 6 are formed so as to electrically connect parts of the transparent conductive film 7 to each other and electrically connect the transparent conductive film 7 to the terminal section (where a contact hole 11 is formed in FIG. 7).

The wiring lines 6 shown in FIG. 7 have a wider line width in the terminal section (terminal section for detecting electric charges) in the same manner as FIG. 11.

In this embodiment, a double layer film made of the Al layer and the Mo layer is used for the wiring lines 6, but the structure of the wiring lines 6 is not limited to such. A double layer film made of an Al layer and an MoNb layer, a triple layer film made of an Mo layer, an Al layer, and an Mo layer, a triple layer film made of an MoNb layer, an Al layer, and an MoNb layer, or the like, for example, may be employed.

Alternatively, the wiring lines 6 may be made of an element chosen from Ta, W, Ti, Mo, Al, Cu, Cr, Nd, Nb, and the like that are low-resistance metal, or may have a multilayer structure, as necessary, made of alloy materials or compound materials that are mainly made of the above elements.

On a region R1 where the wiring lines 6 and the terminal section are not formed on a surface of the opposite substrate 5 on the viewer's side, i.e., on a region that corresponds to a display region of the liquid crystal display panel unit 3, the transparent conductive film 7 made of a material that has high transmittance and relatively small resistivity, such as ITO (Indium Tin Oxide) and IZO (Indium Zinc Oxide), for example, is formed in the same shape as that of the conductive film 251 shown in FIG. 11.

In the terminal section, in the same manner as the configuration shown in FIG. 11, the transparent conductive film 7 is formed over the wiring line 6 such that the wiring line 6 does not make direct contact with an air layer in a region where the contact hole 11 is formed.

More specifically, as shown in FIG. 7, the liquid crystal display device-integrated touch panel 1 has the electrode forming region R1, a wiring forming region R2, and a terminal section forming region R3. In the region R1, the transparent conductive film 7 is formed in a prescribed shape on the display region of the liquid crystal display panel unit 3. In the region R2, the double layer film that is made of the Al layer and the Mo layer having a prescribed pattern is formed on a non-display region, which is located at the periphery of the display region of the liquid crystal display panel unit 3. In the region R3, a double layer film that is made of the Al layer and the Mo layer having a prescribed pattern and the transparent conductive film 7 covering this double layer film are formed on the non-display region, which is located at the periphery of the display region of the liquid crystal display panel unit 3.

In this embodiment, ITO is used for the transparent conductive film 7.

As shown in FIG. 7, on the entire surface of the opposite substrate 5 on the viewer's side, a first protective film 8 made of a silicon oxide film or a silicon nitride oxide film is formed so as to cover the wiring lines 6 and the transparent conductive film 7. A second protective film 9 made of a silicon nitride film is formed so as to cover the first protective film 8. A third protective film 10 made of a transparent resin film is formed so as to cover the second protective film 9.

That is, in the liquid crystal display device-integrated touch panel 1, the protective film formed on the surface of the opposite substrate 5 on the viewer's side, which will be described later in detail, is formed of a multilayer film of the first protective film 8, the second protective film 9, and the third protective film 10.

A configuration of the liquid crystal display panel unit 3 provided in the liquid crystal display device-integrated touch panel 1 will be described below.

As shown in FIG. 7, the liquid crystal display panel unit 3 has the opposite substrate 5 and an active matrix substrate 13 disposed to face each other sandwiching a liquid crystal layer 15 therebetween.

On a surface of the opposite substrate 5 on the reverse side from the surface on the viewer's side (i.e., on a surface of the opposite substrate 5 facing the backlight unit 4), a color filter layer 12 of respective colors including a black matrix layer is formed. Further, although not shown, a common electrode layer, an alignment film layer, and the like are also formed thereon.

It is preferable that, in the wiring forming region R2 and the terminal section forming region R3 on the non-display area located in the periphery of the display region in the liquid crystal display panel unit 3, the black matrix layer be formed on the surface of the opposite substrate 5 on the side not facing the viewer.

On the other hand, on the surface of the active matrix substrate 13 making contact with the liquid crystal layer 15, a TFT element forming layer 14 is formed. The TFT element forming layer 14 formed on the active matrix substrate 13 has a configuration in which a gate bus line and gate electrode layer, a gate insulating layer, an amorphous silicon layer as a semiconductor layer, a source-drain electrode layer in which source electrodes, drain electrodes, and data bus lines are formed, and an insulating layer are formed in this order.

Also, although not shown in the figure, a pixel electrode layer that is electrically connected to the drain electrodes and an alignment film layer are formed on the TFT element forming layer 14.

In this embodiment, transparent glass substrates having heat resistance are used as the opposite substrate 5 and the active matrix substrate 13 to allow for a heat treatment process at a relatively high temperature, and the like. However, if a heat treatment process at a relatively high temperature is not performed, for example, the above-mentioned substrates are not limited to the transparent glass substrate, and a transparent film such as a polyethylene terephthalate film, a polycarbonate resin, an acrylic resin, for example, may be used.

In this embodiment, a TN liquid crystal display panel is used for the liquid crystal display panel unit 3, but the liquid crystal display panel unit 3 is not limited to such. It is apparent that a VA liquid crystal display panel, an IPS liquid crystal display panel, or the like, for example, can be also used for the liquid crystal display panel unit 3.

In this embodiment, a liquid crystal display device-integrated touch panel is described as an example of a display device-integrated touch panel, but the present invention is not limited to such. Any display device-integrated touch panel can be used as long as the substrate of the display device on the display surface side is also used as a base of a touch panel unit.

The principle of the capacitive touch panel unit 2 in detecting a coordinate position at which a finger (or a pen) touches will be described below.

When a finger touches the surface of the touch panel, a state of the electric field between respective electrodes (conductive film) is changed by the finger, and a small current is generated. Using a value of this current, a distance between the location where the finger touched and the respective terminal sections can be calculated. This way, the location where the finger touched can be detected.

Although not shown in the figure, the capacitive touch panel unit 2 may have a configuration in which the transparent conductive film 7 is not patterned in a striped shape as in FIG. 11, but is formed to be a planar shape having terminals on the four corners thereof. The respective terminals are electrically connected to a contact position detection circuits through prescribed signal lines.

In this configuration, alternating-current voltages of the same phase and having the same potential are applied to the respective terminals, and the currents that pass through the respective terminals are detected. Using detection values of the currents passing through the respective terminals, a coordinate position at which the finger touches is detected.

In this embodiment, the capacitive touch panel unit 2 is provided with the transparent conductive film 7 patterned in a striped shape as shown in FIG. 11. Therefore, in contrast to the capacitive touch panel having terminals at four corners of the conductive film in a planar shape, which can detect only a single touch, the touch panel having the transparent conductive film patterned in a striped shape can detect multiple touch positions with a higher degree of detection accuracy as compared with the touch panel that can detect only a single touch.

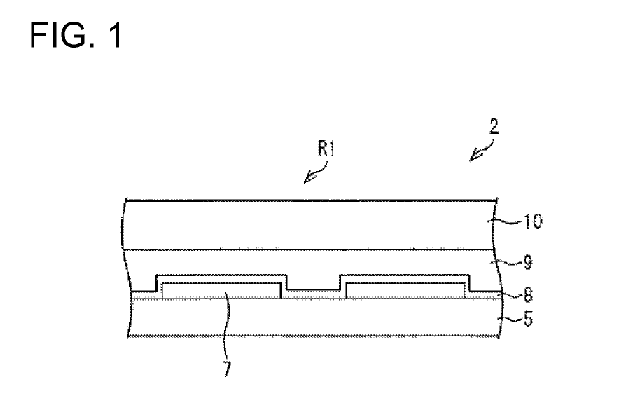

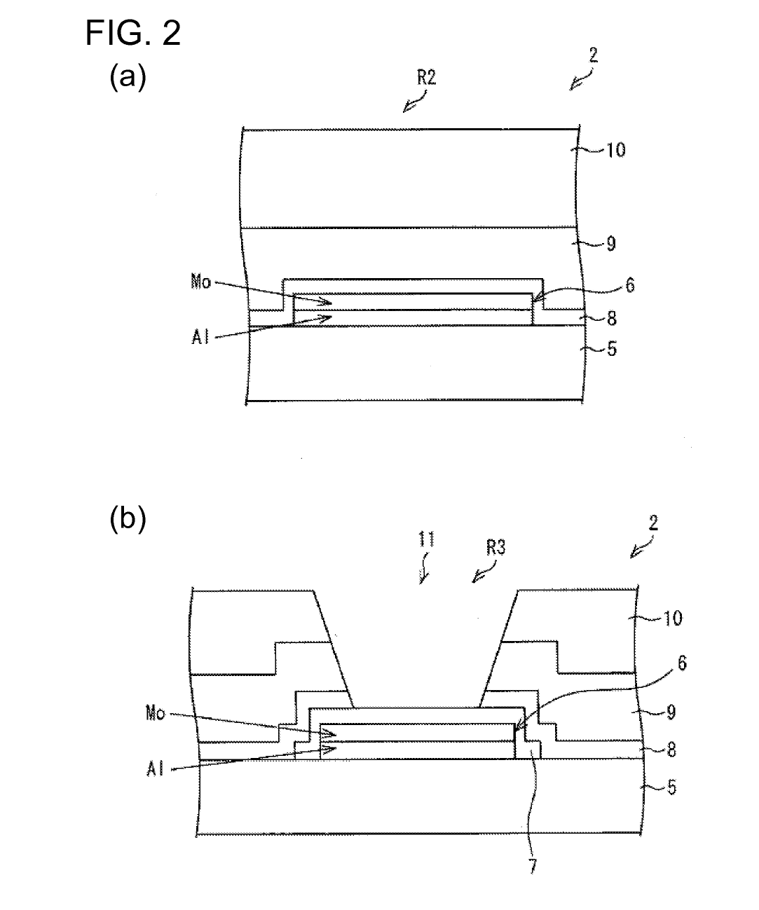

Below, with reference to FIGS. 1 and 2, the protective film, which is formed on the viewer's side of the opposite substrate 5 provided in the liquid crystal display device-integrated touch panel 1, will be described below in detail.

FIG. 1 is a schematic cross-sectional view showing the conductive film (electrode) forming region R1 in the touch panel unit 2 of the liquid crystal display device-integrated touch panel 1.

FIG. 2(a) is a schematic cross-sectional view showing the wiring forming region R2 in the touch panel unit 2 of the liquid crystal display device-integrated touch panel 1. FIG. 2(b) is a schematic cross-sectional view showing the terminal section forming region R3 in the touch panel unit 2 of the liquid crystal display device-integrated touch panel 1.

As shown in FIG. 1, on an entire surface of the opposite substrate 5 having the transparent conductive film 7 formed thereon, the first protective film 8 made of a silicon oxide film or a silicon nitride oxide film (made of SiO₂, SiON, or the like), for example, is formed so as to cover the transparent conductive film 7.

It is generally known that it takes a relatively long time to remove the silicon oxide film or the silicon nitride oxide film by dry etching, and when the above-mentioned film is etched by dry etching using a resist formed in a prescribed pattern by photolithography as a mask, the resist may be burnt.

Therefore, it is preferable that the film thickness of the silicon oxide film or the silicon nitride oxide film be 100 nm or less.

In this configuration, the silicon oxide film or the silicon nitride oxide film of the protective film is formed to have a film thickness of 100 nm or less. Therefore, it is possible to prevent the resist from being burnt even when a dry etching is performed to the protective film to form a contact hole therein.

As shown in FIG. 1, the second protective film 9 made of a silicon nitride film (made of as an SiN_{X} film or the like) is formed so as to cover the first protective film 8.

According to this configuration, although the first protective film 8 of the protective film is formed to have a film thickness of 100 nm or less, the second protective film 9 made of a silicon nitride film, which is etched relatively fast by dry etching, is formed on the first protective film 8 so as to be relatively thick. Therefore, a coverage on the wiring lines 6, the transparent conductive film 7, and the like can be improved, and the protective film having high reliability can be formed regardless of tapered shapes of the wiring lines 6, the transparent conductive film 7, and the like.

Also, as shown in FIG. 1, in the protective film provided in the liquid crystal display device-integrated touch panel 1, it is preferable that the first protective film 8 made of the silicon oxide film or the silicon nitride oxide film be formed in a layer below the second protective film 9 made of the silicon nitride film.

That is, the first protective film 8 is formed so as to make direct contact with the opposite substrate 5, the wiring lines 6, the transparent conductive film 7, and the like. The second protective film 9 is formed so as to cover the first protective film 8.

In this configuration, at a contact interface with the components such as the opposite substrate 5, the wiring lines 6, and the transparent conductive film 7, the first protective film 8 made of the silicon oxide film or the silicon nitride oxide film, which is less likely to come off compared to the second protective film 9 made of the silicon nitride film, is formed as a layer making contact with the opposite substrate 5, the wiring lines 6, the transparent conductive film 7, and the like.

Therefore, according to the above configuration, it becomes possible to prevent the protective film from coming off when an optical member, i.e., a polarizing plate, formed on the protective film is reworked. As a result, the productivity can be improved.

As shown in FIG. 1, the third protective film 10 made of a transparent resin film is further formed so as to cover the second protective film 9.

For the transparent resin film, an epoxy resin, an acrylic resin, or the like can be used. In this embodiment, a photosensitive acrylic resin composition that can be patterned in a prescribed shape by exposure is used in view of the contact hole 11 that will be formed in the terminal section forming region R3 as shown in FIG. 2(b).

The transparent resin film can be formed by spin coating, slit coating, screen printing, or the like.

As shown in FIG. 2(a), in the same manner as the protective film formed in the electrode forming region R1 shown in FIG. 1, the protective film formed in the wiring forming region R2 has a configuration in which the first protective film 8 made of the silicon oxide film or the silicon nitride oxide film, the second protective film 9 made of the silicon nitride film, and the third protective film 10 made of the transparent resin film are laminated.

According to this configuration, the protective film on the wiring forming region R2 where corrosion tends to occur is formed of a multilayer film of the silicon nitride film, the silicon oxide film or the silicon nitride oxide film, and the transparent resin film. When the protective film is made only of the transparent resin film as in the conventional example, the protective film absorbs moisture in the air, the moisture reaches the wiring lines, and the wiring lines are corroded after prolonged use of the display device. However, with the above-mentioned configuration, it is possible to prevent this problem, and therefore, the liquid crystal display device-integrated touch panel 1 with long-term reliability can be achieved.

Further, as shown in FIGS. 1 and 2, in the protective film, the transparent resin film is formed in a layer above the silicon nitride film and the silicon oxide film or the silicon nitride oxide film. Also, the protective film is not formed as one substrate of the liquid crystal display panel unit 3 (opposite substrate 5). Therefore, the transparent resin layer in the protective film can be formed to have elasticity, and it becomes possible to suppress damage to the transparent resin layer of the protective film.

The substrate needs to have a thickness of about 0.1 mm to 0.5 mm in order to secure strength. However, the transparent resin layer of the protective film can be formed thin with a film thickness of 2 μm to 10 μm. Therefore, the transparent resin layer can have elasticity.

When the prescribed films such as the color filter film and the alignment film, for example, are formed on a surface of the opposite substrate 5 on the side not facing the viewer in the liquid crystal display panel unit 3 (i.e., on a surface of the opposite substrate 5 facing the backlight unit 4), the opposite substrate 5 needs to be transferred with the back side thereof facing up. At this time, the support pins that are the substrate carriers make contact with the transparent resin layer (third protective film 10) of the protective film. However, because the protective film is not used as the opposite substrate 5, and the transparent resin layer of the protective film can be formed to have elasticity, a pinhole (crack) is unlikely to be formed. This way, it becomes possible to prevent a pinhole (crack) from being formed and to prevent breaking or corrosion of the wiring lines 6. As a result, the liquid crystal display device-integrated touch panel 1 with long-term reliability can be achieved.

The first protective film 8 is made of the silicon oxide film or the silicon nitride oxide film, which takes a relatively long time to be removed by dry etching. Therefore, in view of a process of forming the contact hole 11 in the terminal section forming region R3 as shown in FIG. 2(b), the first protective film 8 is formed to have a film thickness of 100 nm or less. The second protective film 9 made of the silicon nitride film, which is etched relatively fast by dry etching, is formed thicker than the first protective film 8. The third protective film 10 made of the transparent resin film is formed using a photosensitive acrylic resin composition.

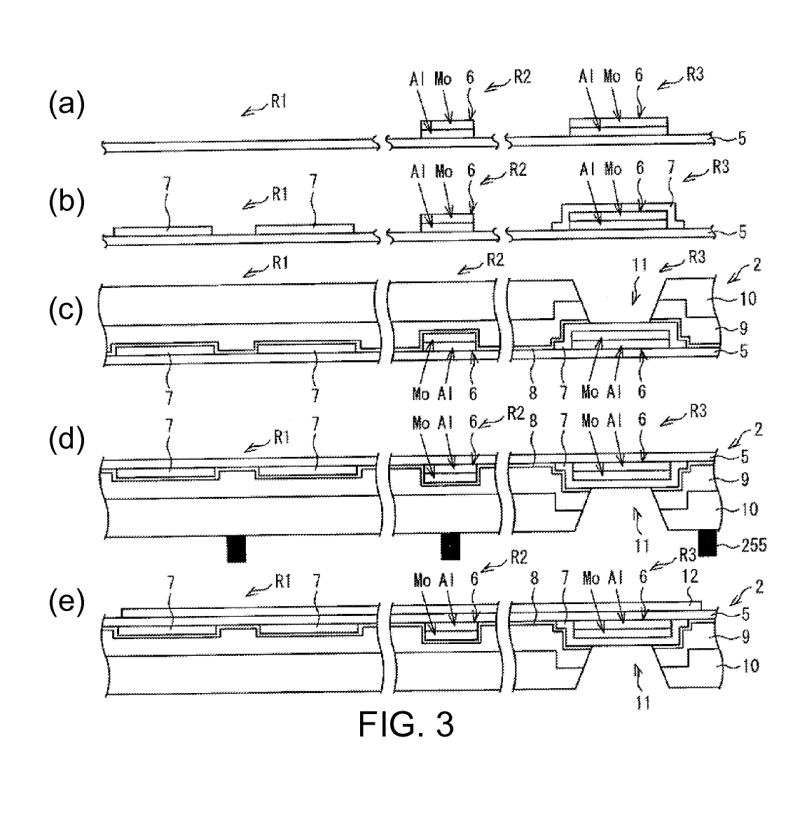

A process of manufacturing the touch panel unit 2 of the liquid crystal display device-integrated touch panel 1 and a process of manufacturing a conventional touch panel unit 2a will be described below with reference to FIGS. 3 to 7. Also, problems of a conventional touch panel 1a integrated with a liquid crystal display device provided with the conventional touch panel unit 2a will be described below.

FIG. 3 is a schematic diagram for explaining a process of manufacturing the touch panel unit 2 of the liquid crystal display device-integrated touch panel 1.

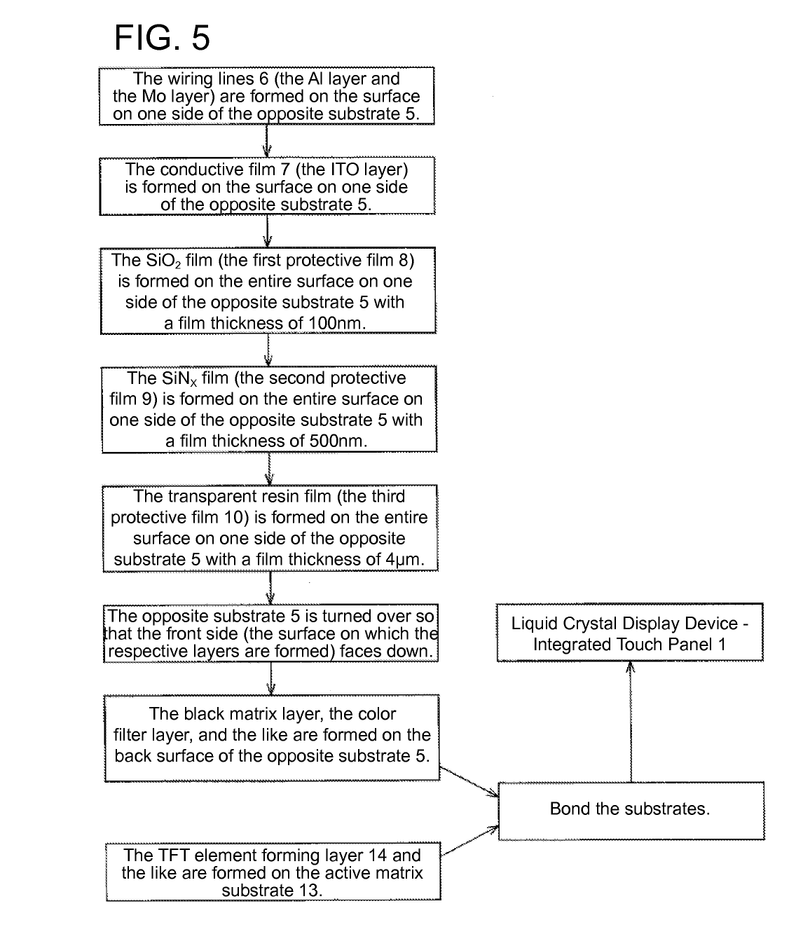

FIG. 5 is a diagram showing an overview of the process of manufacturing the liquid crystal display device-integrated touch panel 1.

Respective steps shown in FIG. 5 will be described below with reference to FIGS. 3 and 7.

As shown in FIG. 3(a), first, on an entire surface on one side of the opposite substrate 5, an Al layer and an Mo layer are deposited by sputtering. Next, a resist film having a prescribed pattern is formed so as to cover the Al layer and the Mo layer. Thereafter, using this resist film as a mask, the Al layer and the Mo layer are etched. This way, the wiring lines 6 are formed in the wiring forming region R2 and in the terminal section forming region R3.

As shown in FIG. 3(b), on the entire surface on one side of the opposite substrate 5 (i.e., the surface on which the wiring lines 6 are formed), an ITO film is deposited by sputtering. Next, a resist film having a prescribed pattern is formed so as to cover the ITO film. Thereafter, using this resist film as a mask, the ITO film is etched. This way, the conductive film 7 is formed in the electrode forming region R1 and in the terminal section forming region R3.

As shown in FIG. 3(c), on the surface on one side of the opposite substrate 5, a protective film having a triple layer structure is formed.

As shown in the figure, first, on the entire surface on one side of the opposite substrate 5, the first protective film 8 made of an SiO₂ film is formed by PECVD method to have a film thickness of 100 nm. Next, the second protective film 9 made of an SiN_{X} film is formed with a film thickness of 500 nm by PECVD method so as to cover the SiO₂ film. Thereafter, the third protective film 10 made of a transparent resin film is formed with a film thickness of 4 μm so as to cover the SiN_{X} film.

In the terminal section forming region R3, the first protective film 8 and the second protective film 9 are etched by dry etching using, as a mask, the photosensitive third protective film 10, which was patterned in a prescribed shape (so as to form part of the contact hole 11) by exposure, thereby forming the contact hole 11.

In the above manufacturing process, it is preferable that, at the contact interface with the components such as the opposite substrate 5, the wiring lines 6, and the transparent conductive film 7, the first protective film 8 made of the SiO₂ film that is less likely to come off compared to the second protective film 9 made of the SiN_{X} film be formed as a layer making contact with the opposite substrate 5, the wiring lines 6, the transparent conductive film 7, and the like.

Therefore, in this embodiment, the step of forming the first protective film 8 made of the SiO₂ film is performed before the step of forming the second protective film 9 made of the SiN_{X} film is performed.

As shown in FIG. 3(d), the opposite substrate 5 is turned over such that the front side (the surface on which the protective film is formed) faces down, and thereafter, the opposite substrate 5 is transferred to the next manufacturing process, while the front surface of the opposite substrate 5 makes contact with the support pins 255 that are the substrate carriers.

On the front surface of the opposite substrate 5, the third protective film 10 made of the elastic transparent resin film is formed. This way, even when the front surface of the opposite substrate 5 makes contact with the support pins 255 that are the substrate carriers, a pinhole (crack) is unlikely to be formed.

Therefore, it becomes possible to prevent a pinhole (crack) from being formed and to prevent the wiring lines 6 from being broken or corroded. As a result, the liquid crystal display device-integrated touch panel 1 with long-term reliability can be manufactured.

As shown in FIG. 3(e), on the back surface of the opposite substrate 5, the color filter layer 12 of respective colors including a black matrix layer, a not-shown common electrode, and a not-shown alignment film are formed. This way, the opposite substrate 5 having the touch panel unit 2 can be fabricated.

On the other hand, as shown in FIG. 7, on the active matrix substrate 13 disposed to face the opposite substrate 5 having the touch panel unit 2, the TFT element forming layer 14, not-shown pixel electrodes, and a not-shown alignment film are formed.

The opposite substrate 5 having the touch panel unit 2, which was fabricated as described above, and the active matrix substrate 13 are bonded to each other. Thereafter, liquid crystal that forms the liquid crystal layer 15 is vacuum-injected. This way, the liquid crystal display panel unit 3 having the touch panel unit 2 is fabricated.

Instead of vacuum-injecting liquid crystal that forms the liquid crystal layer 15, the ODF method in which liquid crystal is dripped on one of the opposite substrate 5 and the active matrix substrate 13 and the substrates are thereafter bonded to each other may be employed.

This way, the liquid crystal display device-integrated touch panel 1 shown in FIG. 7, which is provided with the backlight unit 4 emitting planar and uniform light to the liquid crystal display panel unit 3 having the touch panel unit 2, can be fabricated.

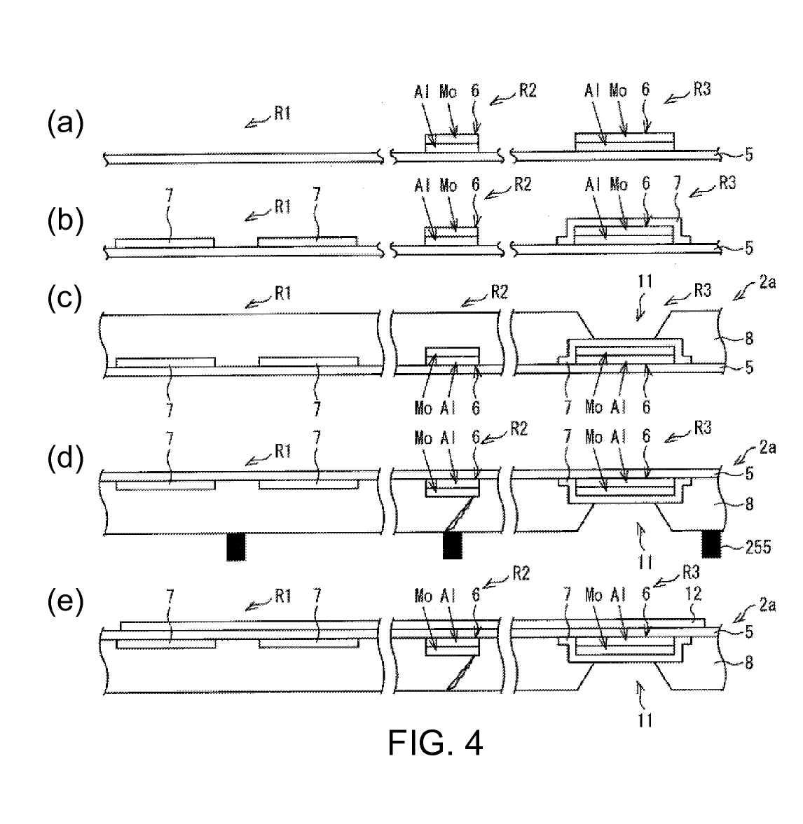

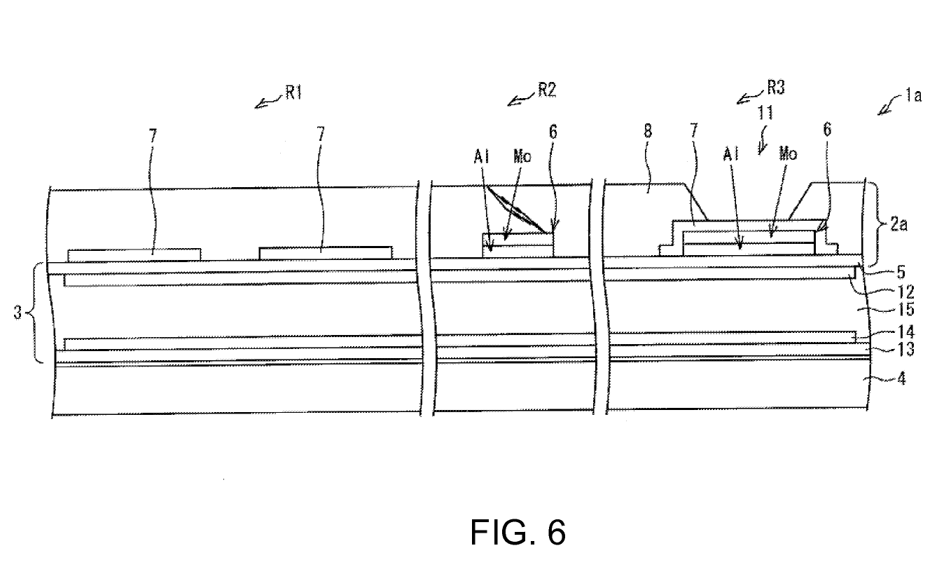

A process of manufacturing the conventional touch panel unit 2a and the conventional touch panel 1a integrated with the liquid crystal display device having the conventional touch panel unit 2a will be described with reference to FIGS. 4 and 6.

FIG. 4 is a schematic diagram for explaining a process of manufacturing the touch panel unit 2a of the conventional touch panel 1a integrated with the liquid crystal display device.

FIG. 6 is a schematic cross-sectional view showing the conventional touch panel 1a integrated with the liquid crystal display device.

The manufacturing processes shown in FIGS. 4(a) and 4(b) are the same as those shown in FIGS. 3(a) and (b) described above. Therefore, the description thereof will not be repeated.

As shown in FIG. 4(c), on the entire surface on one side of the opposite substrate 5, the first protective film 8 made of an SiO₂ film is formed thick by PECVD method, making the single layer protective film 8.

In this configuration, the protective film is formed of the thick SiO₂ film, which needs a relatively long time to be removed by dry etching. Therefore, when the contact hole 11 is formed, a resist used as a mask may be burnt.

Further, the SiO₂ film is not elastic and has a high degree of hardness. Therefore, as shown in FIG. 4(d), when the opposite substrate 5 is turned over such that the front side (the surface on which the protective film is formed) faces down and is transferred to the next manufacturing process with the front surface of the opposite substrate 5 making contact with the support pins 255 that are the substrate carriers, the SiO₂ film is susceptible to a pinhole (crack).

A manufacturing process shown in FIG. 4(e) is the same as the manufacturing process shown in FIG. 3(e) described above. Therefore, a description thereof will not be repeated.

The conventional touch panel unit 2a fabricated in the manner described above is likely to have a pinhole (crack) formed in the protective film. FIG. 6 is a diagram showing the conventional touch panel 1a integrated with the liquid crystal display device that has a pinhole (crack) in a protective film.

As shown in FIG. 6, when a pinhole (crack) is made in the protective film (the first protective film 8), the wiring lines 6 may be broken or corroded due to the pinhole (crack). This makes it difficult to manufacture a liquid crystal display device-integrated touch panel that can ensure long-term reliability.

In the above-mentioned touch panel unit 2a provided in the conventional touch panel 1a integrated with the liquid crystal display device, the protective film was made of the SiO₂ film, but the same problem occurs in other configurations such as when the protective film is made of an SiN_{X} film.

In the display device-integrated touch panel of the present invention, it is preferable that the silicon oxide film or the silicon nitride oxide film in the protective film be formed in a layer below the silicon nitride film in a thickness direction of the insulating substrate.

In this configuration, at a contact interface with the components such as the insulating substrate, the conductive film, and the wiring lines, the silicon oxide film or the silicon nitride oxide film, which is less likely to come off as compared with the silicon nitride film, is formed as a layer making contact with the insulating substrate, the conductive film, the wiring lines, and the like.

Therefore, according to the above configuration, it becomes possible to prevent the protective film from coming off when optical members such as a planarizing plate formed on the protective film are reworked. As a result, productivity (yield) can be improved.

In the display device-integrated touch panel of the present invention, it is preferable that the silicon oxide film or the silicon nitride oxide film be formed to have a film thickness of 100 nm or less.

It is generally known that it takes a relatively long time to remove the silicon oxide film or the silicon nitride oxide film by dry etching, and therefore, when the above-mentioned film is etched by dry etching using a resist formed in a prescribed pattern by photolithography as a mask, the resist may be burnt.

In this configuration, the silicon oxide film or the silicon nitride oxide film of the protective film is formed to have a film thickness of 100 nm or less. Therefore, it is possible to prevent the resist from being burnt even when a contact hole is formed in the protective film by dry etching.

Further, in this configuration, although the silicon oxide film or the silicon nitride oxide film of the protective film is formed to have a film thickness of 100 nm or less, the silicon nitride film, which is etched relatively fast by dry etching, is formed so as to make contact with the silicon oxide film or the silicon nitride oxide film. Due to the presence of the silicon nitride film, coverage over the wiring lines and the like can be improved, and therefore, the protective film having high reliability can be formed regardless of tapered shapes of the wiring lines and the like.

In the display device-integrated touch panel of the present invention, it is preferable that the display device be a liquid crystal display device.

In the display device-integrated touch panel of the present invention, it is preferable that a color filter layer be formed on a surface on the other side of the insulating substrate.

In the display device-integrated touch panel of the present invention, it is preferable that an alignment film be formed on a surface on the other side of the insulating substrate.

In this configuration, because the display device is a liquid crystal display device, the color filter layer and the alignment film, for example, are formed on the surface on the other side of the insulating substrate. When the color filter film, the alignment film, and the like are formed, the insulating substrate needs to be turned over so as to be transferred with the front side facing down. At this time, support pins that are substrate carriers make contact with a transparent resin layer of the protective film.

In this configuration, the protective film is not formed as one substrate of the liquid crystal display device, and therefore, the transparent resin layer of the protective film can be formed to have elasticity, which makes the protective film less likely to have a pinhole (crack). Therefore, it becomes possible to prevent the wiring lines from being broken or corroded as a result of a pinhole (crack), and the display device-integrated touch panel with long-term reliability can be achieved.

In the method of manufacturing the display device-integrated touch panel of the present invention, it is preferable that, in the process of forming the protective film, the step of forming the silicon oxide film or the silicon nitride oxide film be performed before the step of forming the silicon nitride film is performed.

According to this manufacturing method, in the process of forming the protective film, the step of forming the silicon oxide film or the silicon nitride oxide film is performed before the step of forming the silicon nitride film is performed. Therefore, the silicon oxide film or the silicon nitride oxide film, which is less likely to come off as compared with the silicon nitride film, is formed as a contact layer making contact with the insulating substrate, the conductive film, the wiring lines, and the like.

This way, the protective film can be prevented from coming off when optical members such as a polarizing plate, for example, formed on the protective film are reworked. Therefore, the highly productive method of manufacturing the display device-integrated touch panel can be achieved.

The present invention is not limited to the respective embodiments described above, and various modifications can be made without departing from the scope of the claims. Embodiments obtained by appropriately combining the techniques disclosed in different embodiments are included in the technical scope of the present invention.

### INDUSTRIAL APPLICABILITY

The present invention can be applied to a display device-integrated touch panel.

### DESCRIPTION OF REFERENCE CHARACTERS

1 liquid crystal display device-integrated touch panel (display device-integrated touch panel)
2 touch panel unit
3 liquid crystal display panel unit
5 opposite substrate (insulating substrate)
6 wiring
7 transparent conductive film (conductive film)
8 first protective film (protective film)
9 second protective film (protective film)
10 third protective film (protective film)
11 contact hole
12 color filter layer of respective colors including black matrix layer
13 active matrix substrate
14 TFT element forming layer
15 liquid crystal layer
R1 electrode forming region
R2 wiring forming region
R3 terminal section forming region

1. A display device-integrated display device-integrated touch panel, comprising:
a capacitive touch panel that is formed on a surface on one side of an insulating substrate and that comprises: a conductive film; a terminal for detecting an electric charge; wiring electrically connecting the conductive film to the terminal; and a protective film formed to cover the conductive film and the wiring, the touch panel detecting a position touched from outside by using electrostatic capacitance formed between the conductive film and a pressing object as a result of a pressure applied from the outside; and
a display device formed on the other side of the insulating substrate, the display device using the insulating substrate as a substrate on a display surface side,
wherein the protective film is formed of a multilayer film made of a silicon nitride film, a silicon oxide film or a silicon nitride oxide film, and a transparent resin film, and
wherein the transparent resin film is formed in a layer above the silicon nitride film and the silicon oxide film or the silicon nitride oxide film in a thickness direction of the insulating substrate.

2. The display device-integrated touch panel according to claim 1, wherein the silicon oxide film or the silicon nitride oxide film of the protective film is formed in a layer below than the silicon nitride film in a thickness direction of the insulating substrate.

3. The display device-integrated touch panel according to claim 1, wherein the silicon oxide film or the silicon nitride oxide film is formed to have a film thickness of 100 nm or less.

4. The display device-integrated touch panel according to claim 1, wherein the display device is a liquid crystal display device.

5. The display device-integrated touch panel according to claim 4, wherein, on a surface on the other side of the insulating substrate, a color filter layer is formed.

6. The display device-integrated touch panel according to claim 4, wherein, on the surface on the other side of the insulating substrate, an alignment film is formed.

7. A method of manufacturing a display device-integrated touch panel that comprises:
a capacitive touch panel that is formed on a surface on one side of an insulating substrate and that comprises: a conductive film; a terminal for detecting an electric charge; wiring electrically connecting the conductive film to the terminal; and a protective film formed to cover the conductive film and the wiring, the touch panel detecting a position touched from outside by using electrostatic capacitance formed between the conductive film and a pressing object as a result of a pressure applied from the outside; and
a display device formed on the other side of the insulating substrate, the display device using the insulating substrate as a substrate on a display surface side,
the method comprising:
in a process of forming the protective film, a step of forming a silicon nitride film, a step of forming a silicon oxide film or a silicon nitride oxide film, and a step of forming a transparent resin film,
wherein the step of forming the transparent resin film is performed after the step of forming the silicon nitride film and the step of forming the silicon oxide film or the silicon nitride oxide film,
wherein the method further comprises:
turning over the insulating substrate such that a front side faces down after the step of forming the transparent resin film; and
forming a prescribed film on a surface on the other side of the insulating substrate.

8. The method of manufacturing the display device integrated touch panel according to claim 7, wherein, in the process of forming the protective film, the step of forming the silicon oxide film or the silicon nitride oxide film is performed before the step of forming the silicon nitride film is performed.
